(19) United States
(12) Patent Application Publication
(10) Pub. No.: US 2003/0103635 A1
(43) Pub. Date: Jun. 5, 2003

(54) Active noise reduction

(76) Inventors: Selwn Edgar Wright, West Yorkshire (GB); Branislav Vuksanovic, Derby (GB); Hidajat Atmoko, Huddersfield (GB)

Correspondence Address: HARRINGTON & SMITH, LLP, 4 RESEARCH DRIVE, SHELTON, CT, 06484-6212, US

(21) Appl. No.: 10/204,828

(22) PCT Filed: Feb. 23, 2001
(86) PCT No.: PCT/GB01/00775

(30) Foreign Application Priority Data
Feb. 24, 2000 (GB) 0004243.2

(51) Int. Cl. H04B 15/00

(52) U.S. Cl. 381/93; 381/83; 381/66

(57) ABSTRACT

A system (100) for controlling noise comprises an array (2) of concelling tranducers (loudspeakers) (2a). Located some distance away from cancelling array (2) is a detection system (3) comprising a series of microphones (3a), the system casting an acoustic “shadow” or quiet region (4). Located on or adjacent the primary source (1) emitting the noise to be controlled is a synchronising sensor (5) which may be a microphone, vibration transducer or electrical transducer, the output of sensor (5) being fed, along with the output from detection array (3), into an adaptive control system (102) the output of which is fed back to the cancelling units (2). The adaptive control system (102) comprises a low pass filter (15) producing a dc component V from a mathematical convolver (multiplier) (14), and a digital oscillator (16) which generates the cancelling frequency which is controlled by V. Also included arc frequency multipliers (17, 18 and 19) which multiply (2, 3) and n times respectively.

The present invention relates to apparatus and a method for active noise reduction, particularly, though not exclusively, in large confined three dimensional spaces, or in unconfined spaces, ie outdoors.

Active noise reduction, or active noise control (ANC) as it is also called, works on the principle of reducing sound from a primary source by combining it with sound of the same amplitude but opposite phase (“anti-noise”) from a secondary source. The concept has been applied and investigated in a number of different technological fields, including fighter pilots' headsets, aircraft fuselages, and truck and car interiors, with moderate success. However, the noise cancellation region in such applications is small, typically less than one half of an acoustic wavelength from the detector because of, amongst other things, standing waves and diffuse fields. The systems commonly employed for noise control in such enclosed situations are therefore not suitable for use outdoors or in enclosures significantly larger than those in the conventional application area (many multiples of the acoustic wavelength).

It is therefore an aim of the present invention to provide active noise control which is effective for sound reduction in large, unconfined spaces.

It is a further aim of the present invention to provide active noise control which addresses the problems of conventional active noise control systems, whether referred to herein or otherwise.

According to a first aspect of the present invention there is provided a system for controlling sound from a primary source, including at least one secondary source for emitting sound, at least one detector for detecting any residual sound being the combined sound from the primary and secondary sources, feedback means for adjusting the sound emitted by the secondary source so as to minimise the residual sound at the detector thereby maximising the cancellation of the sound from the primary source, wherein the sound from the primary source is cancelled along the direction of its propagation.

This is achieved in the preferred embodiment by successive alignment of primary source, secondary source and detector along a common axis in the direction of noise reduction, which gives an extended “acoustic shadow”(e.g not limited to one half of an acoustic wavelength from the detector). Preferably, at least in use, the primary source, secondary source and detector are aligned successively along a common axis in the direction of noise reduction. Because the primary source sound is cancelled along its direction of propagation and ideally also close to its origin, the shadow is capable (at least in theory) of extending indefinitely. Generally in conventional systems, by contrast, the primary source, secondary source and detector are not in successive alignment and therefore the secondary sound does not propagate along the same direction as the primary source sound. As a result the length of the cancellation region is necessarily limited.

It is preferred that the secondary source is located as close as possible to the primary source and the detector as far away as possible from the secondary source.

Preferably, the sound emitted by the secondary source is convolved with the propagating sound wave from the primary source.

Preferably, the secondary source emits sound in response to a drive signal.

Preferably, the drive signal is derived from the primary source sound.

By “derived from” it is meant either directly obtained from, such as by measurement or sensing/detection techniques, or related to, or coupled with in the sense of phase-locking and similar techniques.

Preferably, both the phase and the amplitude of the sound from the secondary source are adjusted.

Thus, the system creates an extended noise controlled region or “acoustic shadow” downstream from the primary and secondary sources in the direction of the detector. Within this region noise from the primary source may be minimised, by adjusting the sound from the secondary source until its amplitude at the detector is equal to and its phase opposite to that of the sound from the primary source.

Preferably, a feedback signal from the detector is utilised to modify the responses of a filter through which the drive signal passes.

Preferably, the filter is a finite impulse (FIR) or infinite impulse (IIR) response adaptive filter.

More preferably, for greater stability said filter is a finite impulse response filter.

For the cancellation of complex (broadband or discrete frequency) noise, the filter is preferably a multi-tap or coefficient IIR or FIR filter.

Conveniently, there is associated with the filter an adaptive algorithm, which may be embodied in computer software, such as for example an LMS (least mean square) algorithm, which takes as input the error signal (E) derived from the detector, and provides an output which adjusts the adaptive weights in the filter which in turn adjust the secondary source and detector output.

Preferably, the adaptive algorithm operates continuously until the signal derived from the detector is minimised.

Conveniently, the signal derived from the detector is proportional to the difference between the sound from the primary source at the detector and the sound from the secondary source at the detector (“the error E”)

Thus, the adaptive algorithm, filter, secondary source and detector collectively operate to minimise E, i.e. make the sound from the secondary source equal the primary source noise but of opposite phase.

Preferably, the signal used to drive the secondary source is obtained from the primary source using a sensor device which is more preferably a microphone or equivalent. This may be a suitably shielded directional or multi-pole microphone. The microphone may be situated very close and directed towards the primary source or directed away and/or insulated from the secondary source. This reduces the acoustic feedback effect from the secondary source.

According to a second aspect of the present invention there is provided a method of controlling sound from a primary source, the method including driving at least one secondary sound source to emit sound therefrom, detecting any residual sound being the combined sound from the primary and secondary sources and adjusting the sound emitted by the secondary source so as to minimise the residual sound thereby maximising the cancellation of the sound from the primary source, wherein the sound from the primary source is cancelled along its direction of propagation.

Preferably, the secondary source(s) is driven by a drive signal derived from the primary source.

Preferably, the method includes the steps of adjusting the amplitude and phase of the sound from the secondary source.

The apparatus and method of the present invention described in the preceding paragraphs is suitable for the cancellation of any type of noise e.g. random (broad band), multi-frequency aperiodic, multi-frequency periodic or single frequency.

When addressing the particular problem of cancellation of single frequency noise, the signal used to drive the secondary source is preferably synthesized, using for example a software harmonic generator. This is then synchronised in both phase and frequency with a signal measured from the primary source, using either an acoustic, vibrational, electric or electromagnetic sensor depending upon the physical nature of the primary source and on the content of the sound radiated.

Conveniently, the sensed sound is convolved with the synthesized sound, low pass filtered and the resultant dc component used to control the frequency and phase of the synthesized sound. This process continues until the synthesized sound is identical to the primary source sound in frequency and phase, in which case the dc component V becomes zero and there is no further adjustment.

Preferably, the filter is a two-tap FIR filter.

Preferably, the system includes means for locating a stability region N for a given acoustic cancellation frequency and system transfer function, and more preferably includes means for maintaining the system's operation at or close to the centre of its stability band.

Such location means as referred to in the preceding paragraph preferably comprises means for periodically making system loop transfer function measurements (for example using white noise impulse response techniques or equivalent), between the secondary source and detector.

For a stability region N, these measurements are then used to initially determine and then adjust the phase (i.e. the number of samples advance nₐ) automatically to compensate for the propagation path delay changes in the retarded sample number nᵣ between source and detector.

If the measured system transfer function changes rapidly due to environmental or other effects, this location and adjustment technique can be repeated with appropriate periodicity.

Alternatively the nₐ number can be adapted automatically and continuously to minimise E (the error signal) or V (the dc voltage which is zero for phase lock), both of which indicate the centre band operation.

The nₐ number can be adapted automatically, continuously or with appropriate frequency to minimise E (the error signal) or V (the dc voltage which is zero for phase lock), both of which indicate the centre band operation.

Further, to avoid transient instability, during transient environmental changes, the system parameters (filter weights) can be momentarily frozen.

Alternatively, the adaptive time constant can be made momentarily large, by making the adaptive step size (μ) momentarily small.

The present invention as set out above has been hitherto described particularly in relation to the cancellation of complex noise and noise of a single frequency, but the invention may also be applied to control predictable (periodic) multi-frequency noise, and in this case, the adaptive control system preferably includes a series of single frequency adaptive cancellers which are connected in parallel and drive the secondary source. Each canceller is fed with a single synthesized drive signal having harmonically related frequencies with each other (i.e. multiples of the fundamental frequency of the primary source). Each harmonic canceller is then adapted individually, in the manner hereinbefore described, to cancel or reduce the contribution of each harmonic frequency in the primary source, for example by using an adaptive filter or equivalent.

Preferably, each filter is a two-tap FIR filter (i.e. a multi-two tap filter for periodic noise, one two-tap for each frequency harmonic). For each harmonic frequency, each nₐ is determined and adjusted, for example, using white noise or minimising E or V or other methods as described previously to operate each frequency in the centre of a given stability band.

Returning to complex noise (unpredictable noise), for example speech, music, and rapidly varying periodic noise and aperiodic impulsive noise. In this case the frequency domain concept is no longer very useful. It is more appropriate to consider the time domain alignment of the inverted secondary cancelling time history with the primary time history to be cancelled at the detector microphone.

Also for unpredictable noise it may be impractical to synthesis the sound, it is therefore measured directly from the primary source using a microphone, or it's equivalent, as previously described. Further the multi-two tap monochromatic FIR filters may be replaced with one long multi-tap FIR filter of sufficient length to cover the primary signal spectrum bandwidth to be cancelled.

As the electromechanical transfer function of the cancelling system is a function of frequency, it's effect is to distort the secondary cancelling signal, through frequency dispersion, compared to the primary signal. To compensate for this frequency distortion a fixed modified impulse response filter representing the electromechanical transfer function of the hardware is used to modify a copy of the primary source signal in the adaptive algorithm. Also the adaptive nₐ sample advance, used to compensate for each frequency delay for predictable noise, is now used to retard the advanced secondary time history, so as to align with the primary signal at the detector microphone.

The basic cancelling unit according to an embodiment of the present invention comprises a primary source, a secondary source, and a detector all axially aligned in that order. Such a basic cancelling unit produces a deep but narrow shadow, whereas for a wider shadow an array of secondary sources and detectors is required.

To produce a diverging acoustic shadow “anti-sound beam”, particularly from non-compact primary sources (i.e. source size greater than one half acoustic wavelength) there is conveniently provided a plurality of secondary sources and/or a plurality of detectors, arranged in a preferably diverging configuration, and contained preferably within shadow control angles.

According to a third aspect of the present invention there is provided a system for controlling sound from a primary source, the system including a plurality of secondary sources for emitting sound and at least one detector for detecting any residual sound being the combined sound from primary and secondary sources, feedback means for adjusting the sound emitted by the secondary sources so as to minimise the residual sound thereby maximising the cancellation of the sound from the primary source, wherein the sound from the primary source is cancelled by the sound from each secondary source along a direction of propagation of the primary source sound.

The use of a number of secondary sources and detectors is particularly suitable for a non-compact primary source and/or wide shadow angles.

Preferably, each secondary source has associated therewith means for individually adjusting at least one characteristic of the sound emitted therefrom.

The secondary sources and/or detectors may be arranged within planes, and the number of detectors may be equal to the number of secondary sources, but this is, not the only possible configuration and any number of secondary sources may be arranged with any number of detectors in any desired configuration, planar or otherwise. The secondary sources and or detectors may be arranged within planes preferably within control angles and the number of detectors is preferably equal to the number of secondary sources.

Where there are a plurality of secondary sources and detectors, total system robustness (integrity) is preferably achieved by making individual transfer functions around each secondary source/detector loop as dissimilar as possible. This is to minimise the conditioning number K, i.e the ratio of the eigen maximum value divided by eigen minimum value. This can be achieved for instance through asymmetries in the system geometry, unequal propagation paths and dissimilar component electromechanical transfer functions. However equivalent propagation distances of multiples of acoustic half wavelengths should be avoided. They result in particularly large valves of K and therefore instability.

Large secondary source and microphone array dimensions with short separation distances between arrays gives lower frequency instability peaks and lower peak (K) values. Whereas small secondary source and microphone array dimensions with large separation distances between arrays gives higher instability frequencies and higher peak values.

In a preferred embodiment for use with a wide shadow angle and/or non-compact primary source ideally an array of basic cancelling units is provided, each cancelling unit comprising a successive alignment of primary source, secondary source, and detector The amplitude and phase of each secondary source being adjusted, for example through an adaptive filter, to minimise the total sound at all the detectors. Best results are obtained when these basic cancelling units are used in groups, confined within diverging control angles (both azimuthal and elevation) thus forming a deep, well defined acoustic shadow within the control angles where individual alignment of primary, secondary and detection systems is now not so critical.

Where a number of basic cancelling units are used for the cancellation of discrete frequencies, it is preferred to operate all the units at the centre of their appropriate stability bands, and to align all stability bands automatically for each frequency. This may be implemented through measured system transfer functions which are then used to initially determine and then adjust the number of samples advance nₐ automatically, as previously described, corresponding to each propagation path between each source and detector.

The technique can be repeated periodically, or nₐ adapted to minimise E or V, or the adaptive weights frozen, or the adaptive time constant increased as discussed previously, if the system transfer function is changing through environmental or other changes.

If the system transfer function is changing rapidly, through environmental or other changes, the adaptive weights can be momentarily frozen, or the adaptive time constant increased temporarily, as discussed previously.

For unpredictable noise, to compensate for hardware distortion, the electromechanical impulse response may be used in each adaptive loop algorithm. To align the secondary time histories at the detector microphones, for each loop, the propagation nₐ number may be initially calculated for each propagation path between each secondary source and detector using impulse response techniques and/or the nₐ number can be automatically adjusted to find and maintain the alignment by minimising E.

The system or method may be used for controlling unpredictable noise. The system or method for controlling unpredictable noise may comprise an adaptive control system and may include a single adaptive canceller which drives the secondary source.

The or each canceller may be fed with a signal measured directly from the primary source using a microphone or it's equivalent to cancel or reduce the primary source, for example by using an adaptive filter or equivalent.

The filter may be a single long multi-tap FIR filter to cancel or reduce the complete primary source.

The secondary signal distortion may be compensated by a fixed modified electromechanical impulse response function and it's signal alignment with the primary signal, at the detection microphone, may be implemented through an automatic nₐ calculation using the secondary source-detection microphone distance which may be determined and adjusted using white noise impulse techniques or minimising E or V or other methods.

Any feature of any aspect of any invention or embodiment described herein may be combined with any other feature of any aspect of any invention or embodiment described herein.

Embodiments of the present invention will now be described, by way of example only, with reference to the accompanying drawings in which:

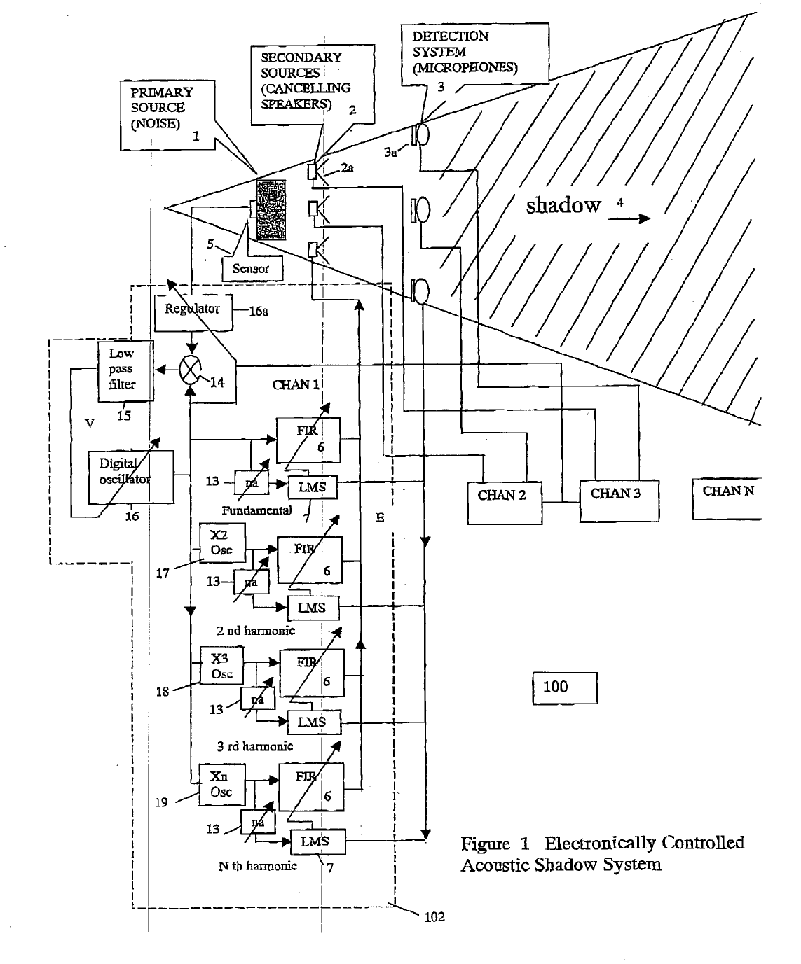

FIG. 1 is an overview of an active noise control system according to the present invention;

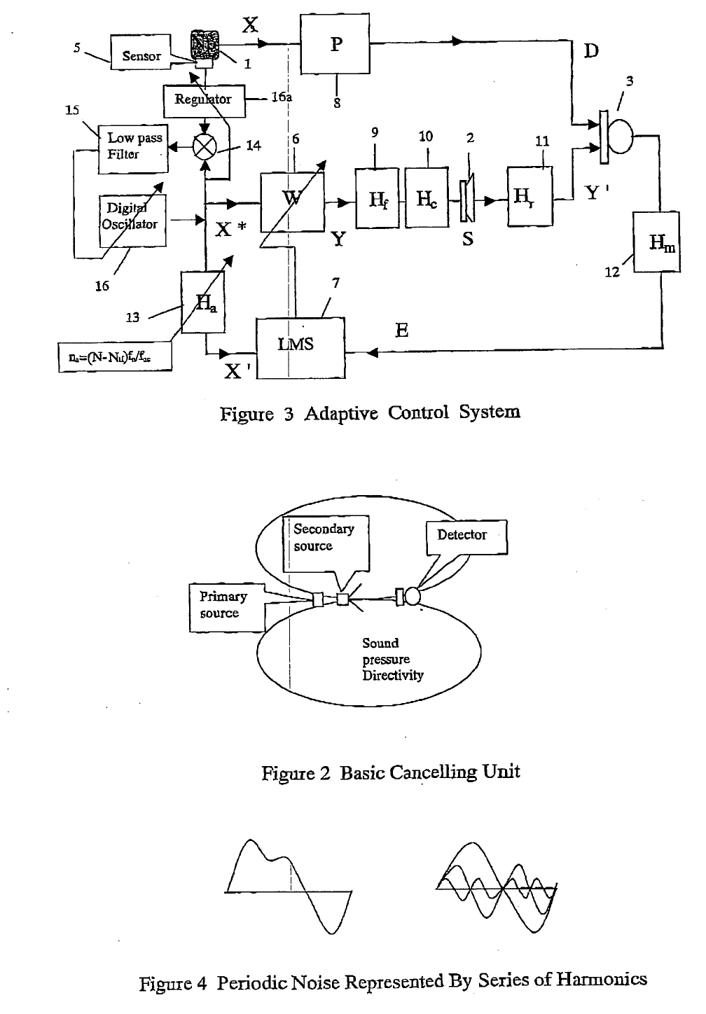

FIG. 2 illustrates a basic cancelling unit;

FIG. 3 illustrates the adaptive control system utilised in the present invention;

FIG. 4 illustrates the use of harmonics in the present invention.

Referring to the drawings, a directional active noise control system 100 comprises an array 2 of cancelling transducers (loudspeakers) 2a. Located some distance away from cancelling array 2 is a detection system 3 comprising a series of microphones 3a, the system casting an acoustic “shadow” or quiet region 4. Located on or adjacent the primary source 1 emitting the noise to be controlled is a synchronising sensor 5. This may be a microphone, vibration transducer or electrical transducer. The output of sensor 5 is fed, along with the output from detection array 3, into an adaptive control system 102 the output of which is fed back to the cancelling units 2.

The adaptive control system 102 comprises a low pass filter 15 producing a dc component V from a mathematical convolver (multiplier) 14, and a digital oscillator 16 which generates the cancelling frequency which is controlled by V. The amplitude regulator 16a maintains the signal level from the primary source to match that of the phase lock loop so as to bring it within the normal operating range of the phase lock loop. Also included are frequency multipliers 17, 28 and 19 which multiply 2, 3 and n times respectively.

The adaptive control system 102 will now be described in more detail with reference in particular to FIGS. 1 and 3. The output from sensor 5 adjacent primary noise source Np is used to drive three adaptive processes before the processed signal is used to drive the secondary source S which is represented by the cancelling speaker 2. Each of the three adaptive processes routes will now be described in detail.

In the first adaptive process, the secondary source output is adjusted to maintain the total noise, represented by error E from detector 3, at a minimum. Sound X from the primary source Np travels along the primary propagation path P to the cancelling point where it arrives as sound D. At the same time, a copy X* of sound X is modified to sound Y by a weight adjustment W in an adaptive finite response (FIR) filter 6. The functions H_{f}(9), H_{c}(10) and Hₘ(12) represent the transfer functions of the anti-aliasing and quantization filters 6, the cancelling speaker 2a and the microphone 3a respectively, and Hᵣ represents the transfer function for the propagation distance between the cancelling speaker and the microphone. Sound Y is modified as it passes through the environment represented by Hᵣ (11) where it becomes Y′ at the cancelling point. At the cancelling point, the error E between the detected sounds D and Y′ is then fed into an adaptive algorithm 7, such as an LMS algorithm, the output of which is used to adjust W to make Y′ equal but opposite to D. This process continues until error E is minimised. The weight adjustment filter is a two tap FIR filter or equivalent, which is the most efficient computational filter type for single frequency cancellation.

In the second route, a copy X* of sound X is fed through a sample (phase) advance adjustment 13 represented by function 8, into the adaptive algorithm 7. The purpose of adjustment 13 is to adjust nₐ automatically to locate the selected stability region number N (number of 2Π radians) for a given acoustic cancellation frequency f_{ac}, and total system transfer function N_{tf}. Also to adaptively maintain the system at the centre of its stability band, despite environmental changes. Thus maintaining stability and optimising performance in terms of shadow depth, adaptive speed and spectrum distortion. Computation of nₐ is via any of equations (a) to (c) below:

$${n}_{a} = ( \frac{N - {N}_{emr}}{{f}_{ac}} + \frac{{r}_{sm}}{{c}_{0}} ) {f}_{n} \qquad ( a )$$

or nₐ=(N−Nₑₘᵣ)fₙ/f_{ac}+nᵣ where nᵣ=rₛₘfₙ/cₒ (b)

or nₐ=(N−N_{tf})fₙ/f_{ac} where N_{tf}=Nₑₘᵣrₛₘf_{ac}/cₒ (c)

In the above equations, Nₑₘᵣ is the modified electro-mechanical transfer function i.e. the phase responses of functions H_{f}(9), H_{c}(1), and Hₘ(12) modified by environmental effects such as reflections, rₛₘ is the propagation distance between the individual secondary speakers and the detection microphones, nᵣ is the number of retarded samples through individual propagation delays between speakers 2 and microphones 3 if rₛₘ=0 then Nₑₘᵣ=Nₑₘ, the actual electromechanical transfer function. N_{tf} is the loop transfer function including Nₑₘᵣ and the propagation phase delay Nᵣ=rₛₘf_{ac}/cₒ therefore can be found from Nₑₘᵣ=N_{tf}+Nᵣ. cₒ is the speed of sound and fₙ is the sampling frequency. Thus, for a given stability region N, fₙ and f_{ac}, the adaptability of nₐ with environmental changes is implemented by measuring N_{tf} with the appropriate periodicity, in equation (c), periodically, through well known white nose impulse measurement or other techniques. The adaptability of nₐ to sustained centre band operation through environmental changes can be implemented also through automatic incremental adjustment of nₐ to minimise E or V (both of which indicate centre band operation.

For small rapid deviations in nₐ (for example due to fleeting reflections) the control system parameters can be frozen or alternatively the adaptive speed slowed by reducing adaptive step size μ to avoid short term transient instability. To avoid using FFT (Fast Fourier Transform) repeatedly, to reduce extensive computation, Nₑₘᵣ in equation (a), if similar for all transducers can be measured once and rₛₘ measured directly or calculated automatically from the impulse delay in the aforesaid white noise measurements.

The adaptive processes described in the foregoing paragraphs are embodied in computer software, and to avoid the need for excessive computer memory and to optimise execution speed, each propagation path delay compensation (i.e. updated sample advance nₐ values) between each secondary source 2a and microphone 3a is created through use of a circular pointer buffer memory or equivalent. To store the difference between the largest distance and the actual distance, the shortest propagation path difference (smallest number of samples advance) is stored at the beginning of the buffer and the progressively larger differences over larger segments of the buffer.

The sound utilised for the secondary sources could be measured directly from the primary source Nₚ by using a suitably shielded, directional microphone to reduce the acoustic feedback effect. But more preferably the feedback effect is eliminated completely by deriving the cancelling sound indirectly, which also increases the signal to noise ratio giving greater cancellation depth.

This is implemented in the third route, sound X* is synthesized by a software harmonic generator 16 and synchronised to primary sound X by multiplying it in convolver 14 with a primary source signal (measured with either an acoustic, vibrational or electromagnetic sensor, depending on the type of primary noise source to be controlled). The convolved signal is then filtered through low pass filter 15 and the resulting dc component V used to control the frequency and phase of the digital oscillator 16 until it is locked to the primary source (V=0). Thus producing a very pure primary source cancelling frequency without being physically connected to it. The amplitude control or regulator 16a adjusts the incoming amplitude from the primary source sensor to match that of the phase lock loop. This results in a high signal to noise ratio and deep cancellation whilst avoiding instability due to feedback between secondary source and detector.

The successive alignment of the primary source to be cancelled, the secondary cancelling source and detection system shown in FIG. 2 comprises the basic cancelling unit. It produces maximum sound reduction in the direction of the detector along the system axis, the smaller the primary-secondary source separation distance and the larger the secondary source-detector separation distance the larger the sound reduction. The sound reduction directivity can be cardiod, figure-of-eight (shown in FIG. 2) or four-leaf clover shaped for primary-secondary source distances of

$${r}_{ps} = \frac{λ}{4} , \frac{λ}{2}$$

and λ respectively, where λ is the acoustic wavelength (λ=Cₒ/f_{ac}).

To produce effective shadows over a substantial angle particularly from a non compact primary source (wavelength smaller than the source size) a diverging array of these basic cancelling units, are arranged within shadow control angles both azimuthal and elevation and controlled as a group, as shown in FIG. (1)—the denser the units within the control angles, the deeper the shadow. For simplicity only three cancelling units are shown. Generally the source and detectors are arranged within planes, having an equal number of sources and detectors, but neither of these conditions are essential. From the information received from the detector array, after digital signal processing, the individual secondary speaker outputs are adjusted appropriately, both in phase and amplitude, to minimise the sound, totally or individually at the detectors. The combined effect is to produce a deep sharp shadow, confined within the control angles, having no difficulty producing shadows across complex sound field radiated by the primary source.

The optimum source strength of each secondary source in the array to produce the optimum shadow within the control angles is given by the following matrix condition.

(Qₛ)ₒₚₜ=(C^{H}ₛₘCₛₘ) ⁻¹C^{H}ₛₘPₚₘcₛₘ=ωρe^{-jkrsm}/4πrₛₘ (d)

ξₒₚₜ=Pₚₘ^{H}[I−Cₛₘ(Cₛₘ^{H}Cₛₘ)⁻¹Cₛₘ^{H}]Pₚₘ (e)

Pₚₘ is the primary source field at the detection microphone array that is to be reduced, where ρ is the density of the propagating fluid, k is the wave number (ω/cₒ), ω is the acoustic frequency (2πf_{ac}) and again rₛₘ is the primary-secondary source-microphone separation distance. (Qₛ)ₒₚₜ is the vector of optimum secondary source strengths required to cancel Pₚₘ, where Cₛₘ is a matrix of propagation elements (cₛₘ) between the secondary source array and the detection microphone array, and H is the Hermition transpose of the matrix. ξₒₚₜ is the optimum total squared error at all the microphones and I is the unit matrix. (Qₛ)ₒₚₜ and ξₒₚₜ are obtained through the optimum convergence of the adaptive weights in the FIR filter, using the LMS adaptive algorithm or equivalent, automatically. Physically each secondary source is successively adjusted to minimise the total sound (gradient) at the detection array. The process is continued until the optimum minimum is obtained.

For multiple cancelling units, the stability region N of each adaptive loop, involving all propagation paths between the secondary sources and detectors, for a particular frequency must be aligned and kept aligned through environmental changes. This is essential to maintain maximum stability and cancellation performance. Alignment is achieved by adjusting nₐ for each individual propagation path accordingly between each secondary source and detector, through automatic propagation path transfer function measurement, using white noise/impulse response or other techniques as discussed previously.

Total system stability robustness (system integrity) for a large number of basic cancelling units, is given by the ratio of the maximum (εₘₐₓ) to minimum (εₘᵢₙ) eigen value. Each eigen value is given by the matrix equation

det[εI−C^{H}ₛₘCₛₘ]=0.

Where det is the determinant and I is the unit matrix. For the proposed system of the present invention, peaks in the K=(εₘₐₓ)/(εₘᵢₙ) occur for propagation path differences corresponding to approximately multiples of a half acoustic wavelength. Thus for maximum system robustness, i.e. minimum (εₘₐₓ)/(εₘᵢₙ), the transfer functions of individual propagation paths should be made as dissimilar as possible, but avoiding equivalent path differences of multiples of half acoustic wavelengths which give spectral peaks in K given by

$${f}_{m} = \frac{{c}_{0} c}{ab} ( {N}_{c} - 1 )$$

where m=1,2,3 etc for c much greater than a and b. In this equation, cₒ is the speed of sound, a is the speakers array size, b is the microphones array size and c is the separation of speaker and microphone array planes and N_{c} is the number of units and m is the harmonic number. This includes arranging for f₁ and all subsequent peaks to lie outside the frequency range. This is achieved at the design stage through custom component selection and optimised system geometry, including secondary sources and detectors staggered in their respective arrays, thereby maximising asymmetries in the system geometry and electromechanical transfer functions.

Finally, to reduce repetitive (periodic) machinery noise, the noise 20 can be considered as comprising of a series of pure tones (harmonics) 21, as illustrated in FIG. 4. Periodic noise can be reduced, therefor, by cancelling individual harmonics in parallel, as illustrated in FIG. 1. Digital oscillators 17, 18, 19 are used to generate the individual harmonics, times two, three etc of the fundamental source frequency. Two tap monochromatic FIR filters 6 are used to adapt each frequency component individually. One long (many taps) FIR or IIR (finite and infinite response) filters could also be used to cancel the periodic noise directly. However with present digital processing techniques this approach appears slower and less efficient. Each harmonic is fed to each secondary source, or to the single secondary source, with automatic nₐ calculation for each propagation path and frequency.

For cancelling complex unpredictable (and periodic) noise the primary source is measured directly using a microphone sensor 5 or the equivalent. The signal synthesis and synchronisation mechanisms for predictable noise cancellation are not used. The multi-2 tap filters 6, for multi-frequency cancellation, are replaced by one sufficient long (many taps) FIR or IIR filter to cover the cancellation frequency bandwidth.

The nₐ stability process 13 is replaced by two processes. A fixed electromechanical impulse response function used in each adaptive loop algorithm to compensate for frequency distortion generated by the adaptive hardware. An automatic nₐ adjustment is used to align each of the secondary source time histories with the primary source time history at the detectors, based on each source-microphone path propagation time, measured using white noise impulse response techniques or equivalent.

To maintain time history alignment and avoid cancelling signal distortion, through environmental changes, automatic nₐ adjustment can be implemented through minimising E. For transient environmental changes the adaptive parameters (weights) can be momentarily frozen, or the adaptive system speed slowed using temporary smaller adaptive step sizes. If the propagation environment is changing drastically, then the above two processes may have to be replaced by a repetitively, computationally extensive, complete adaptive loop impulse response measurement containing both the electromechanical and propagation delay functions.

The reader's attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings), may be replaced by alternative features serving the same, equivalent or similar purpose, unless expressly stated otherwise. Thus, unless expressly stated otherwise, each feature disclosed is one example only of a generic series of equivalent or similar features.

The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1. A system for controlling sound from a primary source, including at least one secondary source for emitting sound, at least one detector for detecting any residual sound being the combined sound from the primary and secondary sources, feedback means for adjusting the sound emitted by the secondary source so as to minimise the residual sound at the detector thereby maximising the cancellation of the sound from the primary source, wherein the sound from the primary source is cancelled along the direction of its propagation.

2. A system according to claim 1 wherein, at least in use, the primary source, secondary source and detector are aligned along a common axis in the direction of noise reduction.

3. A system according to claim 1 or claim 2 wherein, at least in use, the secondary source is located as close as possible to the primary source and the detector as far away as possible from the secondary source.

4. A system according to any of the preceding claims wherein the sound emitted by the secondary source is convolved with the propagating sound wave from the primary source.

5. A system according to any of the preceding claims wherein the secondary source emits sound in response to a drive signal.

6. A system according to claim 5 wherein the drive signal is derived from the primary source sound.

7. A system according to claim 6 wherein the drive signal is directly obtained from the primary source sound.

8. A system according to claim 6 wherein the drive signal is related to or coupled with the primary source sound.

9. A system according to any of the preceding claims wherein both the phase and the amplitude of the sound from the secondary source are adjusted.

10. A system according to any of claims 5 to 9 wherein a feedback signal from the detector is utilised to modify the responses of a filter through which the drive signal passes.

11. A system according to claim 10 wherein the filter is a finite impulse (FIR) or infinite impulse (IIR) response adaptive filter.

12. A system according to claim 11 wherein the noise to be controlled is complex (broadband or discrete-frequency) noise and the filter is a multi-tap or coefficient IIR or FIR filter.

13. A system according to any of claims 10 to 12 wherein there is associated with the filter an adaptive algorithm, which takes as input an error signal (E) derived from the detector, and provides an output which adjusts the adaptive weights in the filter which in turn adjust the secondary source and detector output.

14. A system according to claim 13 wherein the adaptive algorithm operates continuously until the signal derived from the detector is minimised.

15. A system according to claim 13 or claim 14 wherein the signal derived from the detector is proportional to the error E which is the difference between the sound from the primary source at the detector and the sound from the secondary source at the detector.

16. A system according to any of claims 5 to 15 wherein the signal used to drive the secondary source is obtained from the primary source using a sensor device such as a microphone.

17. A method of controlling sound from a primary source, the method including driving at least one secondary sound source to exit sound therefrom, detecting any residual sound being the combined sound from the primary and secondary sources and adjusting the sound emitted by the secondary source so as to minimise the residual sound thereby maximising the cancellation of the sound from the primary source, wherein the sound from the primary source is cancelled along its direction of propagation.

18. A method according to claim 17 wherein the secondary source(s) is driven by a drive signal derived from the primary source.

19. A method according to claim 17 or claim 18 wherein the method includes the steps of adjusting the amplitude and phase of the sound from the secondary source.

20. A system according to any of claims 5 to 16, or a method according to any of claims 17 to 19, wherein the noise to be controlled is single frequency noise and the signal used to drive the secondary source is synthesized and synchronised in both phase and frequency with a signal measured from the primary source.

21. A system or method according to claim 20 wherein the sensed sound is continuously convolved with the synthesized sound, low pass filtered and the resultant dc component used to control the frequency and phase of the synthesized sound until the synthesized sound is identical to the primary source sound in frequency and phase, in which case the dc component becomes zero and there is no further adjustment.

22. A system or method according to claim 21 wherein the filter is a two-tap FIR filter.

23. A system or method according to any of claims 20 to 22 wherein the system includes means for locating a selected stability region N for a given acoustic cancellation frequency and system transfer function, and means for maintaining the system's operation at or close to the centre of its stability band.

24. A system or method according to claim 23 wherein the location means comprises means for periodically making system loop transfer function measurements between the secondary source and detector.

25. A system or method according to claim 24 wherein said measurements are then used to initially determine and then adjust the phase (i.e. the number of samples advance nₐ) automatically to compensate for the propagation path delay changes in nᵣ between source and detector.

26. A system or method according to claim 25 wherein said determination and adjustment technique is repeated with appropriate periodicity.

27. A system or method according to claim 25 wherein the nₐ number is adapted automatically, continuously or with appropriate frequency to minimise E (the error signal) or V (the dc voltage which is zero for phase lock), both of which indicate the centre band operation.

28. A system or method according to claim 25 wherein the system parameters (filter weights) are momentarily frozen.

29. A system or method according to claim 25 wherein the adaptive time constant is made large, by making the adaptive step size (μ) small to avoid transient instability.

30. A system or method according to any of the preceding claims wherein the noise to be controlled is predictable (periodic) multi-frequency noise and the adaptive control system includes a series of single frequency adaptive cancellers which are connected in parallel and drive the secondary source.

31. A system or method according to claim 30 wherein each canceller is fed with a single synthesized drive signal having harmonically related frequencies with each other (i.e. multiples of the fundamental frequency of the primary source) and each harmonic canceller is adapted individually, to cancel or reduce the contribution of each harmonic frequency in the primary source, for example by using an adaptive filter or equivalent.

32. A system or method according to claim 31 wherein each filter is a two-tap FIR filter (ie a multi-two tap filter for periodic noise, one two-tap for each frequency harmonic).

33. A system or method according to claim 32 wherein for each harmonic frequency, each nₐ is determined and adjusted using white noise or minimising E or V or other methods.

34. A system according to any one of claims 1 to 16 or a method according to any one of claims 17 to 19 wherein the noise to be controlled is unpredictable noise.

35. A system for controlling sound from a primary source, the system including a plurality of secondary sources for emitting sound and at least one detector for detecting any residual sound being the combined sound from primary and secondary sources, feedback means for adjusting the sound emitted by the secondary sources so as to minimise the residual sound thereby maximising the cancellation of the sound from the primary source, wherein the sound from the primary source is cancelled by the sound from each secondary source along a direction of propagation of the primary source sound.

36. A system according to claim 35 wherein each secondary source has associated therewith means for individually adjusting at least one characteristic of the sound emitted therefrom.

37. A system according to claim 35 or claim 36 wherein the secondary sources and/or detectors are arranged within planes, and the number of detectors is equal to the number of secondary sources.

38. A system according to any of claims 35 to 37 wherein there are a plurality of secondary sources and detectors and total system robustness (integrity) is achieved by making individual transfer functions around each secondary source/detector loop as dissimilar as possible, so as to minimise the conditioning number, i.e. the ratio of the eigen maximum value divided by eigen minimum value.

39. A system according to any of claims 35 to 38 wherein an array of basic cancelling units is provided, each cancelling unit comprising a successive alignment of primary source, secondary source, and detector and the amplitude and phase of each secondary source are adjusted, for example through an adaptive filter, to minimise the total sound at all the detectors.

40. A system according to claim 39 wherein all the units are operated at the centre of their appropriate stability bands, and all stability bands are aligned automatically for each frequency.

41. A system according to claim 40 wherein system transfer functions which include the propagation distance between secondary source and detector are used to initially determine and then adjust the phase (number of samples advance) automatically corresponding to each propagation path between each source and detector.

42. A system according to claim 41 wherein said determination and adjusting technique is repeated periodically.

43. A system according to claim 41 wherein nₐ is adapted to minimise E or V.

44. A system according to claim 41 wherein the adaptive weights are frozen.

45. A system according to claim 41 wherein the adaptive time constant is increased.
